(19) United States
(12) Patent Application Publication
(10) Pub. No.: US 2009/0144048 A1
(43) Pub. Date: Jun. 4, 2009

(54) Method and device for instant translation

(76) Inventors: Yuval Dvorin, Bat Yam (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/998,931

(22) Filed: Dec. 4, 2007

(51) Int. Cl. G06F 17/28

(52) U.S. Cl. 704/3; 704/E19.001

(57) ABSTRACT

Digital translating, using computer program, internet site or mobile phone, for use by one or more people, involving two or more languages, one after the other or simultaneously. Using technologies including voice recognition, language recognition, voice activation, voice-voice translation and voice-text translation. Automatic language recognition and thereby automatic translation to the other languages being used by that group of people. Translation could be vocal or text on a screen or printed. Ability to expand or explain words and phrases. Ability to synopsize words and phrases. Translations and explanations in layman's language or professional language. Ability to translate instantly while one party of the conversation is speaking. Dictionary word source internet connection or local memory.

### FIELD OF THE INVENTION

This invention is in the field of translation and in particular digital translation with language recognition to identify which target language to use.

### BACKGROUND OF THE INVENTION

Prior art in the field of translation is well known. For example, Wipo Patent No. WO 2005015808 issued to Moloi reveals a mobile dictionary with data transfer by SMS and other methods. It does not address the multi-language and language recognition of the present invention.

Russian Patent No. RU 2143135 issued to Kim reveals communication between users speaking different languages with simultaneous translation. It does not address features included in the present invention like speaker recognition and conference calls in multiple languages.

U.S. Pat. No. 7,113,909 issued to Nukaga reveals a method of synthesizing the voice of a stereotypical sentence with arbitrary speech style. The present invention translates, or synopsizes, or expands the original language, or transposes to layman's or professional language.

The present invention reveals methods to make communication easier between speakers of different languages.

### SUMMARY of the INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

An object of this invention is to enable at least two people to have a conversation where the participants are not fluent in the language of the other parties to the conversation. The conversation could be where the participants are physically in each others presence, on a chat program, an internet based call or a conference call on cell-phones.

For example, a person who speaks English who wishes to speak to a Chinese man and a German, could contact the system of this invention on a computer or on his mobile phone and after initializing the program could leave the loudspeaker on and each persons speech would be translated to the other two languages.

Another object of this invention is for the translations to be close to the end of the speech of the speaker being as close as possible to instant translation.

Another object of the invention is for the translation program to use technologies like voice recognition, language recognition, voice activation, voice-voice translation and voice-text translation.

Another object of the invention is for the translating device and program to identify the speaker or the language of the speaker from his voice or from his language and thereby translate into the other languages of the participants. Another object of the invention is for the translation to be done by a computer program in a standing computer or on an internet site or on a mobile phone.

Another object of the invention is for the device to record or print out the original language and the translation in text formation.

Another object of the invention is for the translation to be at levels of language chosen by the user. For example, there could be a layman's language or a professional language level; literal or free translation.

Another object of the invention is for the user to choose words or phrases to be explained or expanded for easier understanding or conversely to be summarized into a synopsis.

Another object of the invention is for the translation program to textually or vocally ask for the identification of the persons taking part in a conversation and their spoken languages. The program would then be able to identify the speaker according to the language spoken and systematically translate the conversation piece by piece into the languages of the other parties present. Headphones or separate screens could be used for the other participants to hear or see the translations in their language.

Another object of the invention is for the program to indicate to a speaker to pause so that the translation may take place.

Another object of the invention is for the translation to be vocally in words or phrases using a language memory in the mobile phone. The word to be translated would be spoken to the phone and the translation given verbally. Alternatively, the instruction could be given textually and the translation verbally or visa versa.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a flow chart of the stages of operation of the translation program.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

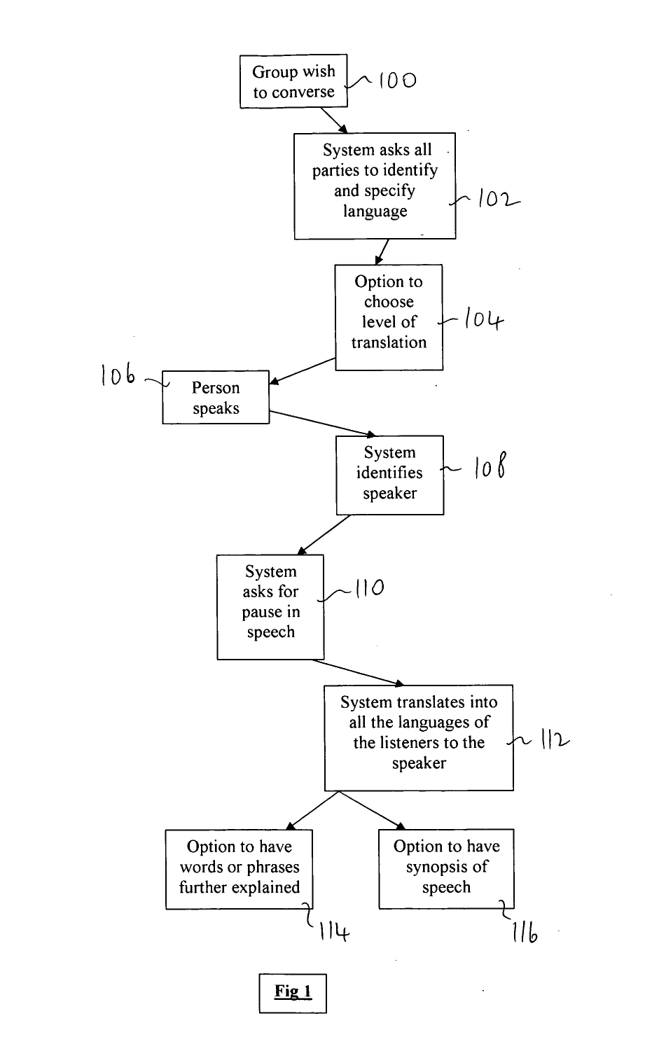

FIG. 1 shows a scenario of this innovation where a group 100 of persons wish to communicate on a conference call or physically around a table but can not speak or understand each others' languages. The system can verbally via loudspeakers or textually on the screen of a computer or cell-phone ask the participants of the group 100 to identify themselves and their spoken language 102. This will enable the system to upload the languages involved in this conversation and be able to identify who is talking using voice recognition technology. If the speaker is the only person who speaks that language in group 100, then the identification of the language spoken will enable the speaker to be identified. Where more than one person speaks the same language, the voice recognition will identify the speaker.

Members of the group 100 can individually choose the level of translation 104 they require. This may vary depending 15 upon the nature and subject matter of the conversation or upon the level of understanding that member has in that language. Even though the member chooses the language, it may not be his mother tongue and he may feel more comfortable with a layman's standard of language. Alternatively, a professional having a conversation with other professionals in the same field could choose to have the translation at a professional standard. The member could choose to have a literal translation where every word used carried significant weight or have a free translation where the general understanding of the conversation sufficed. The choice of language and level of translation could be communicated to the system of this innovation textually or verbally.

When the languages of the participants have been established and each one has chosen his level of translation the system would indicate that the conversation may commence 106. The system could then identify the speaker as each one speaks and thereby translate to the languages required by other participants. This translation could be audible by all the participants and would have to be transmitted to the participants one language after the other. When the translation is heard privately by each participant via, for example, earphones then the translation could be simultaneous.

If a speaker speaks an amount of words that is too much in quantity or difficult to translate efficiently, the system may 15 ask the speaker to pause 110, so that the translation can be done.

After the first speaker has finished and his message has been translated to the language of the other participators, the system would operate likewise for the next speaker. If one person speaks while another is talking the system would identify the second person and ask him to wait until the first speaker has finished. This way all the speakers will be heard in turn and their words are translated 112 for the benefit of the other participants.

A participant who has access to a computer or a mobile phone could contact the system to have given words or phrases explained further 114 or he could request from the system to produce a synopsis of the speech of another participant 116.

What is claimed:

1. A method and device for instant translation comprising,
a. a computer program comprising retrieval means from a multi-lingual dictionary database, voice recognition, language recognition, voice activation, voice-voice translation, voice-text translation,
b. a computer program to memorize the identity and languages used by the conversation participants,
c. an algorithm to identify the language of a speaker and translate to the languages of the other participants of a conversation,
d. choice of type of translation to be at least one of the following namely regular, expanded, explained, synopsized, layman's language, professional language,
whereby two or more persons who do not speak the language of other participants may converse by means of this instant translating method using a computer.

2. A method and device for instant translation as claimed in claim 1 wherein the said program recognizes the voice of the speaker and thereby translates to the languages of the said other participants of the conversation.

3. A method and device for instant translation as claimed in claim 1 wherein the said participants of the conversation communicate by one of the 5 following methods namely, chat texts, internet based communication and cellular phones.

4. A method and device for instant translation as claimed in claim 1 wherein the said translation is made orally.

5. A method and device for instant translation as claimed in claim 1 wherein the said translation is made textually.

6. A method and device for instant translation as claimed in claim 1 further comprising an indicator to signal to the speaker to pause after a given amount of speech to enable the program to translate.

7. A method and device for instant translation as claimed in claim 1 wherein the said a multi-lingual dictionary database is on the internet.

8. A method and device for instant translation as claimed in claim 1 wherein the said a multi-lingual dictionary database is in the memory of the mobile phones of at least one participant of the conversation.

9. A method and device for instant translation comprising,
a. a digital program in a mobile phone comprising retrieval means from a local multi-lingual dictionary database, voice recognition, language recognition, voice activation, voice-voice translation, voice-text translation,
b. a digital program to memorize the identity and languages used by the conversation participants,
c. an algorithm to identify the language of a speaker and translate to the languages of the other participants of a conversation,
d. choice of type of translation to be at least one of the following namely regular, expanded, explained, synopsized, layman's language, professional language,
whereby two or more persons who do not speak the language of other participants may converse by means of this instant translating method using mobile phones.

10. A method and device for instant translation as claimed in claim 1 wherein the said program recognizes the voice of the speaker and thereby translates to the languages of the said other participants of the conversation.

11. A method and device for instant translation as claimed in claim 9 wherein the said participants of the conversation communicate by one of the following methods namely, chat texts, internet based communication and cellular phones.

12. A method and device for instant translation as claimed in claim 9 wherein the said translation is made orally.

13. A method and device for instant translation as claimed in claim 9 wherein the said translation is made textually.

14. A method and device for instant translation as claimed in claim 9 further comprising an indicator to signal to the speaker to pause after a given amount of speech to enable the program to translate.
